(19) United States
(12) Patent Application Publication
(10) Pub. No.: US 2010/0063238 A1
(43) Pub. Date: Mar. 11, 2010

(54) ISOCYANATE TRIMER MODIFIED WITH SILANE OR POLYSILOXANE AND METHOD OF PREPARAING THE SAME

(76) Inventors: Qunchao ZHANG, Yingcheng (CN); Decai WANG, Yingcheng (CN)

Correspondence Address: MATTHIAS SCHOLL, 14781 MEMORIAL DRIVE, SUITE 1319, HOUSTON, TX, 77079, US

(21) Appl. No.: 12/618,676

(22) Filed: Nov. 13, 2009

Related U.S. Application Data
(63) Continuation of application No. PCT/CN2007/070957, filed on Oct. 25, 2007.

(30) Foreign Application Priority Data
May 14, 2007 (CN) 200710052179.5

(51) Int. Cl. C08G 18/61

(52) U.S. Cl. 528/58; 528/44

(57) ABSTRACT

An isocyanate trimer modified with silane or functional polysiloxane and having formula of

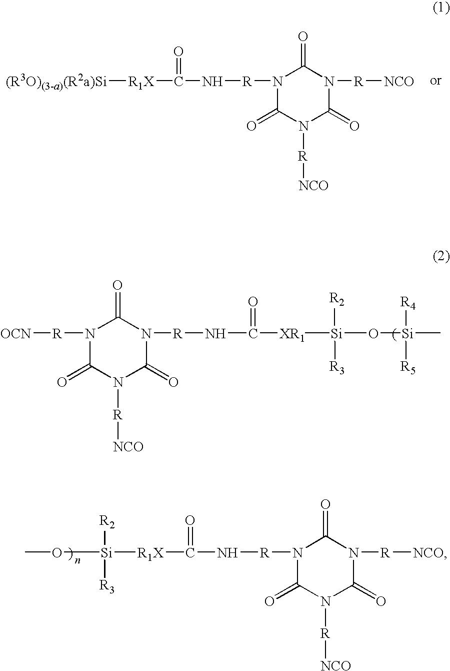

wherein R represents tolyl, ethylphenyl, diphenylmethyl, 1,5-naphthyl, hexamethylene, isophorone, 2,2,6-trimethylcyclohexyl, or 4,4-dicyclohexylmethyl, etc.; R₁ is saturated or unsaturated and linear or branched C₁₋₈ alkyl, cycloalkyl, aryl etc., or a homologue of aromatic hydrocarbon; R² and R³ at each occurrence separately represents C₁₋₆ alkyl, aryl, trialkylsilyl, methoxyalkoxyl; a is an integer from 0 to 3; R₁, R₂, R₃, R₄, and R₅ at each occurrence separately represents saturated or unsaturated and linear or branched C₁₋₁₂ alkyl, cycloalkyl, alkoxyl, or aryl etc.; X represents —NH—, —NHCH₂CH₂NH—, —NHCH₂CH₂NHCH₂CH₂NH—, —N—, —NHCONH—,

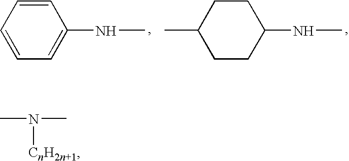

—S—, or —O—, and n is an integer which is ≧0. A method of preparing the compound is also provided.

### CROSS-REFERENCE TO RELATED APPLICATIONS

This application is a continuation of International Patent Application No. PCT/CN2007/070957 with an international filing date of Oct. 25, 2007, designating the United States, now pending, and further claims priority benefits to Chinese Patent Application No. 200710052179.5 filed May 14, 2007. The contents of all of the aforementioned applications, including any intervening amendments thereto, are incorporated herein by reference.

### BACKGROUND OF THE INVENTION

1. Field of the Invention

The invention relates to an isocyanate trimer and a method of preparing the same, and more particularly an isocyanate trimer modified with silane or functional polysiloxane and a method of preparing the same.

2. Description of the Related Art

Nowadays, silicone-modified polyurethane has aroused more and more attention in academy and industry. While maintaining the original excellent performance, silicone-modified polyurethane exhibits improved properties such as adhesion, wear resistance, chemical resistance, heat resistance, weather resistance, electrical insulation, fire retardancy, and hydrophobicity, and can be cured at room temperature. However, the above-mentioned silicone-modified polyurethane mainly focuses on the modification of an isocyanate prepolymer. There are few reports on silicone-modified isocyanate trimer.

The study on preparation and application of isocyanate trimers has been very active. U.S. Pat. Nos. 2,801,244, 5,264,572, 0,109,665, 6,515,125, and 3,996,223 separately discloses a method of preparing an isocyanate trimer, all of which have different yield under different catalytic system. Isocyanate trimers have a high application value and are mainly used in coatings, adhesives, sealants, elastomers, foam plastics and so on, particularly for current production of quick-drying and highly decorative furniture and automobile. However, most isocyanate trimers are solid at room temperature, except that hexamethylene diisocyanate (HDI) trimer is liquid. Therefore, to develop an isocyanate trimer with high compatibility is of great significance.

### SUMMARY OF THE INVENTION

In view of the above-described problems, it is one objective of the invention to provide a modified isocyanate trimer featuring high compatibility. Polyurethane or other polymers (for example, epoxy resins, polymethacrylate, polyacrylamide, and phenolic resin) prepared by the modified isocyanate trimer can improve the heat resistance, weather resistance, electrical insulation, fire retardancy, and hydrophobicity.

It is another objective of the invention to provide a method of preparing the modified isocyanate trimer featuring high compatibility.

To achieve the above objectives, in accordance with one embodiment of the invention, there is provided a modified isocyanate trimer featuring high compatibility, the isocyanate trimer being modified with silane or functional polysiloxane and having formula of

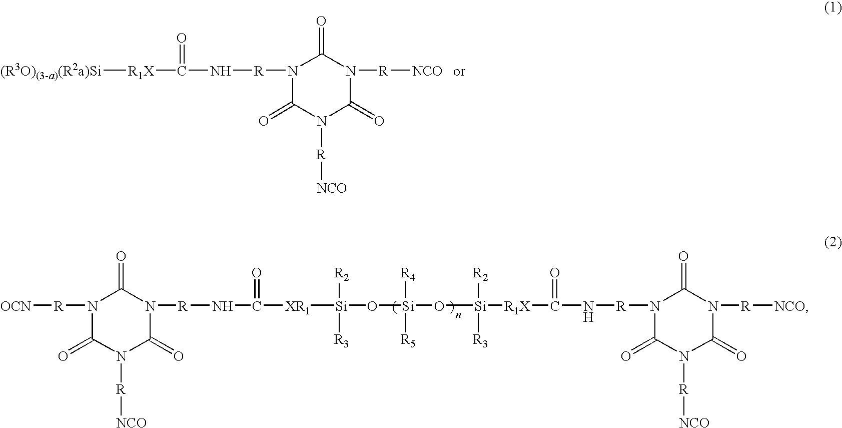

wherein

R represents tolyl, ethylphenyl, diphenylmethyl, 1,5-naphthyl, hexamethylene, isophorone, 2,2,6-trimethylcyclohexyl, 4,4-dicyclohexylmethyl;

R₁ is saturated or unsaturated and linear or branched C₁₋₈ alkyl, cycloalkyl, aryl, or a homologue of aromatic hydrocarbon;

R² and R³ at each occurrence separately represents C₁₋₆ alkyl, aryl, trialkylsilyl, or methoxyalkoxyl;

a is an integer from 0 to 3;

R₁, R₂, R₃, R₄, and R₅ at each occurrence separately represents saturated or unsaturated and linear or branched C₁₋₁₂ alkyl, cycloalkyl, alkoxyl, aryl, or cycloalkoxyl;

X represents —NH—, —NHCH₂CH₂NH—, —NHCH₂CH₂NHCH₂CH₂NH—, —N—, —NHCONH—,

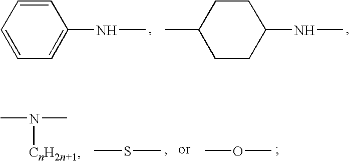

and

n is an integer which is ≧0.

In accordance with another embodiment of the invention, there is provided a method of preparing the modified isocyanate trimer represented by formula (1) or (2) featuring high compatibility, the method comprising steps of:
a) dissolving an isocyanate trimer into an inert solvent;
b) adding dropwise to a mixture of silane or functional polysiloxane and a catalyst;
c) stirring the resultant solution of b) at room temperature and in a dry environment; and
d) removing said inert solvent with reduced pressure distillation.

In a class of this embodiment, the isocyanate trimer has a formula of

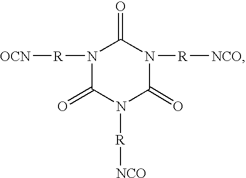

wherein R represents tolyl, ethylphenyl, diphenylmethyl, 1,5-naphthyl, hexamethylene, isophorone, 2,2,6-trimethylcyclohexyl, or 4,4-dicyclohexylmethyl.

In a class of this embodiment, the isocyanate is toluene diisocyanate (TDI), ethylbenzene diisocyanate (EDI), methylene diphenyl diisocyanate (MDI), 1,5-naphthalene diisocyanate (NDI), hexamethylene diisocyanate (HDI), isophorone diisocyanate (IPDI), 1,4-diisocyanate-2,2,6-trimethyl cyclohexane (TMCDI), or 4,4-bis(isocyanatecyclohexyl)methane (HMDI).

In a class of this embodiment, the silane or functional polysiloxane has a formula of

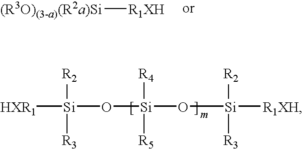

wherein R² and R³ at each occurrence separately represents C₁₋₆ alkyl, aryl, trialkylsilyl, or methoxylalkoxyl and a is an integer from 0 to 3; R₁, R₂, R₃, R₄, and R₅ at each occurrence separately represents saturated or unsaturated and linear or branched C₁₋₁₂ alkyl, aryl, cycloalkyl, alkoxyl, or cycloalkoxyl; X represents —NH—, —NHCH₂CH₂NH—, —NHCH₂CH₂NHCH₂CH₂NH—, —N—, —NHCONH—,

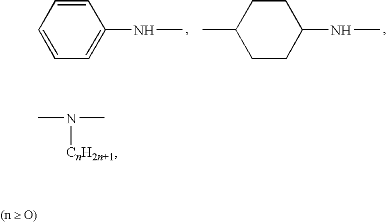

—S—, or —O—, and m is an integer from 0 to 30.

In a class of this embodiment, the catalyst is an organic tin compound including but not limited to dibutyltin dilaurate, dibutyltin maleate, dibutyltin diacetate, dibutyltin dilaurylmercaptan, and dimethyltin dichloride.

In a class of this embodiment, the amount of the catalyst is between 0.01 and 0.5 weight % of the total amount of the trimer and silicon compound.

In a class of this embodiment, the inert organic solvent which does not react with the reactants is hydrocarbon, chlorinated hydrocarbon, ester, or ether.

In a class of this embodiment, the hydrocarbon solvent is petroleum ether, linear or branched hydrocarbon with low boiling point, benzene, toluene, or xylene; the chlorinated hydrocarbon is chloroform, chlorobenzene, dichloromethane, or dichloroethane; ester is ethyl acetate; and ether is aether or tetrahydrofuran.

In a class of this embodiment, a molar ratio of the isocyanate trimer to the active hydrogen of silane or polysiloxane is 1:1.

Advantages of this invention are summarized below:
1. The isocyanate trimer modified with silanes or functional polysiloxanes has low viscosity, low volatile, low toxicity, high functionality, and high tolerance against xylene due to reduced isocyanate polarity, so that the compatibility of trimer with hydroxy resin has been improved significantly. In addition, heat resistance, weather resistance, and adhesion of isocyanate trimer have been further increased due to the introduction of organic silicon.
2. For the isocyanate trimer modified with silanes or functional polysiloxanes of the invention, isocyanate as a reactive functional group can react with polyester diols, polyether diols, hydroxy resins, and other polyols, and siloxane as another reactive functional group can react with inorganic materials or hydroxyl resins to form chemical bonds. In addition, the isocyanate trimer modified with silane or functional polysiloxane can be designed properly in accordance with the type of a polyol or polyol resin, which benefits the combination thereof.
3. For the reaction between isocyanate and active hydrogen of silanes or functional polysiloxanes to prepare carbamate, the introduction of an organometallic catalyst such as dibutyltin dilaurate can help obtain a high yield of product at low temperature (between −50° C. and 30° C.). Particularly, in case it is difficult for isocyanate trimer to react with active hydrogen of silanes or functional polysiloxanes due to space block, or the occurrence of a large amount of by-products at high temperature, the introduction of organic tin catalysts can smooth the reaction.

A monomer of the isocyanate trimer is selected from toluene diisocyanate (TDI), methylene diphenyl diisocyanate (MDI), hexamethylene diisocyanate (HDI), isophorone diisocyanate (IPDI), 1,4-diisocyanate-2,2,6-trimethyl cyclohexane (TMCDI), 4,4-bis(isocyanatecyclohexyl)methane (HMDI), etc.

The silanes or functional polysiloxanes of the invention optionally have sulfhydryl, amino, diamino, triamino, secondary amino, hydroxy, hydroxyalkylamino, phenylamino, ureaalkyl, epoxy, N-alkyl amino, and N,N,N′,N′-tetraalkyl guanidine with hydroxyl.

Particularly, a molar ratio of isocyanate trimer to the active hydrogen of silane or polysiloxane is 1:1.

In one embodiment of the invention, dibutyltin dilaurate, dibutyltin maleate, dibutyltin diacetate, dibutyltin dilaurylmercaptan, and dimethyltin dichloride is used as catalyst.

The reaction can be completed in a chlorinated alkyl solvent such as chloroform, cholorbenzene, dichloromethane, and dichloroethane, in an ether solvent such as aether, tetrahydrofuran, and cycloether, and in a hydrocarbon solvent such as petroleum ether, benzene, toluene, and xylene.

The isocyanate trimers of the invention have good compatibility with acrylic resin. As additives, the isocyanate trimers make acrylic resin with good gloss, scratching and wear resistance, water resistance, solvent resistance, chemical resistance, weather resistance, heat resistance, gloss retention, and good flexibility. In addition, it is also an important modifier of polyurethanes, epoxy resins, polyacrylamides, phenolic resins, etc.

### DETAILED DESCRIPTION OF THE EMBODIMENTS

For further illustrating the invention, experiments detailing a modified isocyanate trimer featuring high compatibility and a method of preparing the same are described below. It should be noted that the following examples are intended to describe and not to limit the invention.

### Example 1

### Compound A

52.2 g of TDI trimer was dissolved in 400 mL of anhydrous tetrahydrofuran (THF), and the solution was added to a mixture of 22.1 g of γ-aminopropyl triethoxysilane and 0.07 g of dibutyltin dilaurate (DBTDL). The resultant solution was stirred for 5 hs at room temperature under a dry environment. Subsequently, THF was removed with reduced pressure distillation and 68.36 g of compound A was obtained, with a yield of 92%. The compound A has a formula of

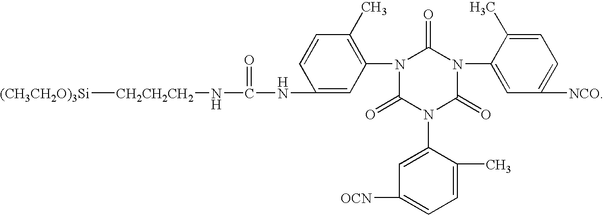

Elemental analysis of C₃₆H₄₁N₇O₉Si: measured value (calculated value) %: C, 58.02 (58.14); H, 5.43 (5.52); N 13.07 (13.19); O, 19.29 (19.38); Si 3.68 (3.77). ¹HNMR (δ/ppm): 0.58 (t, 2H), 1.22 (q, 3H), 1.6 (q, 2H), 2.0 (m, 2H), 2.35 (m, 3H), 2.65 (q, 2H), 3.83 (q, 2H), 6.9 (t, 1H), 7.0 (q, 1H), 7.26 (m, 1H), 7.5 (m, 2H), 7.9 (s, 1H).

### Example 2

### Compound B

52.2 g of TDI trimer was dissolved in 400 mL of anhydrous tetrahydrofuran (THF), and the solution was added to a mixture of 44 g of bis[γ-(triethoxysilyl) propyl]amine and 0.07 g of dibutyltin dilaurate (DBTDL). The resultant solution was stirred for 5 hs at room temperature under a dry environment. Subsequently, THF was removed with reduced pressure distillation and 80.5 g of compound B was obtained, with a yield of 85%. The compound B has a formula of

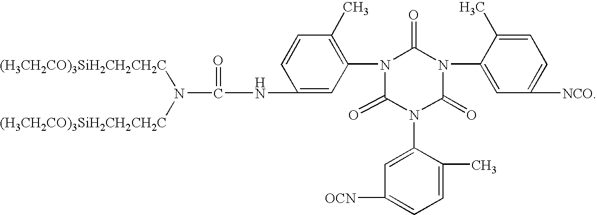

Elemental analysis of C₄₅H₆₁N₇O₁₂Si₂: measured value (calculated value) %: C, 56.89 (57.02); H, 6.33 (6.44); N, 10.26 (10.35); O, 20.16 (20.27); Si, 5.79 (5.91).

¹HNMR (δ/ppm): 0.58 (t, 2H), 1.22 (q, 3H), 1.6 (q, 2H), 2.0 (m, 2H), 2.35 (m, 3H), 2.65 (q, 2H), 3.83 (q, 2H), 6.9 (t, 1H), 7.0 (q, 1H), 7.26 (m, 1H), 7.5 (m, 2H), 7.9 (s, 1H).

### Example 3

### Compound C

52.2 g of TDI trimer was dissolved in 400 mL of anhydrous tetrahydrofuran (THF), and the solution was added to a mixture of 22.2 g of γ-(β-amino-ethylamino) propyltrimethoxysilane and 0.07 g of dibutyltin dilaurate (DBTDL) The resultant solution was stirred for 5 hs at room temperature under a dry environment. Subsequently, THF was removed with reduced pressure distillation and 70.68 g of compound C was obtained, with a yield of 95%. The compound C has a formula of

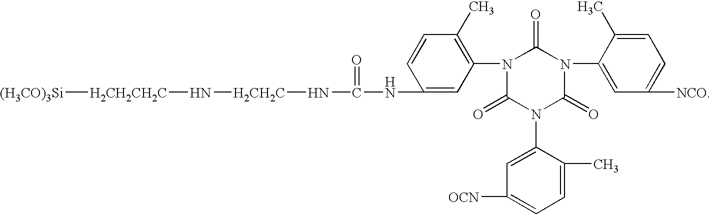

Elemental analysis of C₃₅H₄₀N₈O₉Si: measured value (calculated value) %: C, 56.32 (56.45); H, 5.26 (5.38); N, 14.97 (15.05); O, 19.28 (19.35); Si, 3.69 (3.76). ¹HNMR (δ/ppm): 1.22 (q, 3H), 1.6 (q, 2H), 2.0 (m, 2H), 2.35 (m, 3H), 2.65 (q, 2H), 3.83 (q, 2H), 6.0 (s, 1H), 6.9 (t, 1H), 7.0 (q, 1H), 7.26 (m, 1H), 7.5 (m, 2H), 7.9 (s, 1H).

### Example 4

### Compound D

52.2 g of TDI trimer was dissolved in 400 mL of anhydrous tetrahydrofuran (THF), and the solution was added to a mixture of 26.5 g of γ-(aminoethyl-aminoethylamino)propyltrimethoxysilane and 0.07 g of dibutyltin dilaurate (DBTDL). The resultant solution was stirred for 5 hs at room temperature under a dry environment. Subsequently, THF was removed with reduced pressure distillation and 75.5 g of compound D was obtained, with a yield of 96%. The compound D has a formula of

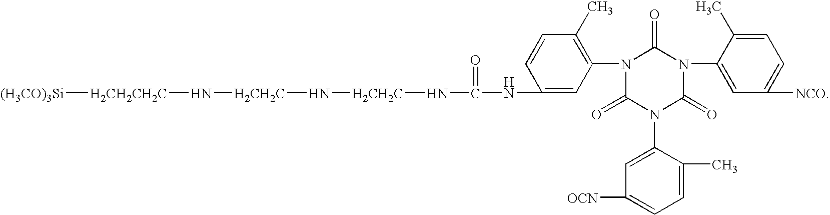

Elemental analysis of C₃₇H₄₅N₉O₉Si: measured value (calculated value) %: C, 56.34 (56.42); H, 5.64 (5.72); N, 15.94 (16.01); O, 16.21 (16.30); Si, 3.42 (3.56).

¹HNMR (δ/ppm): 0.58 (q, 2H), 1.50 (q, 2H), 2.0 (q, 1H), 2.35 (m, 1H), 2.55 (q, 2H), 2.67 (m, 2H), 2.81 (q, 2H), 3.28 (q, 2H), 3.55 (s, 3H), 6.0 (s, 1H), 6.9 (m, 1H), 7.0 (q, 1H), 7.5 (s, 1H), 7.9 (m, 1H).

### Example 5

### Compound E

52.2 g of TDI trimer was dissolved in 400 mL of anhydrous tetrahydrofuran (THF), and the solution was added to a mixture of 22.7 g of anilinomethyltrimethoxysilane and 0.08 g of dibutyltin dilaurate (DBTDL). The resultant solution was stirred for 8 hs at room temperature under a dry environment. Subsequently, THF was removed with reduced pressure distillation and 66.6 g of compound E was obtained, with a yield of 89%. The compound E has a formula of

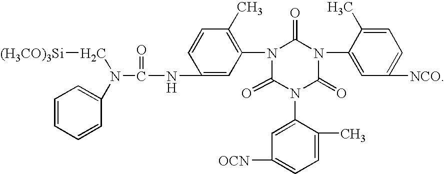

Elemental analysis of C₃₇H₃₅N₇O₉Si: measured value (calculated value) %: C, 59.19 (59.28); H, 4.54 (4.67); N, 12.94 (13.06); O, 19.11 (19.23); Si, 3.66 (3.74).

¹HNMR (δ/ppm): 2.35 (m, 1H), 5 (s, 2H, 2.4), 3.55 (s, 3H), 6.0 (s, 1H), 6.9 (m, 1H), 7.0 (q, 1H), 7.4 (q, 1H), 7.5 (s, 1H), 7.64 (m, 1H), 7.9 (s, 1H).

### Example 6

### Compound F

52.2 g of TDI trimer was dissolved in 400 mL of anhydrous tetrahydrofuran (THF), and the solution was added to a mixture of 21.3 g of p-aminophenyl-trimethoxysilane and 0.08 g of dibutyltin dilaurate (DBTDL). The resultant solution was stirred for 8 hs at room temperature under a dry environment. Subsequently, THF was removed with reduced pressure distillation and 63.0 g of compound F was obtained, with a yield of 86%. The compound F has a formula of

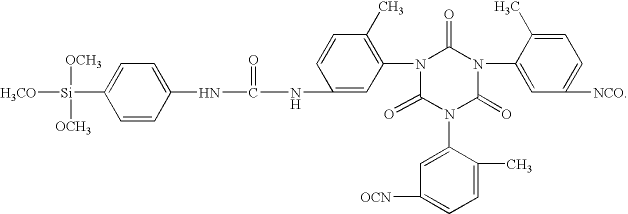

Elemental analysis of C₃₆H₃₃N₇O₈Si: measured value (calculated value) %: C, 69.88 (70.1); H, 4.44 (4.59); N, 13.53 (13.63); O, 17.69 (17.8); Si, 3.76 (3.89).

¹HNMR (δ/ppm): 0.66 (m, 3H), 2.35 (s, 1H), 5 (s, 3H, 3.5), 6.0 (s, 1H), 6.9 (q, 1H), 7.0 (q, 1H), 7.26 (q, 1H), 7.5 (s, 1H), 7.6 (m, 1H), 7.9 (m, 1H).

### Example 7

### Compound G

52.2 g of TDI trimer was dissolved in 400 mL of anhydrous tetrahydrofuran (THF), and the solution was added to a mixture of 23.5 g of n-butylamino-propyltrimethoxysilane and 0.07 g of dibutyltin dilaurate (DBTDL). The resultant solution was stirred for 6 hs at room temperature under a dry environment. Subsequently, THF was removed with reduced pressure distillation and 71.2 g of compound G was obtained, with a yield of 94%. The compound G has a formula of

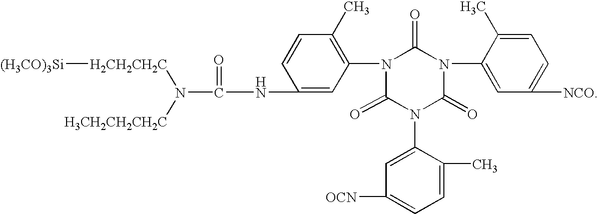

Elemental analysis of C₃₇H₄₃N₇O₉Si: measured value (calculated value) %: C, 58.56 (58.65); H, 5.59 (5.68); N, 12.86 (12.95); O, 18.89 (19.02); Si, 3.62 (3.70).

¹HNMR (δ/ppm): 0.96 (q, 3H), 1.33 (q, 2H), 1.55 (q, 2H), 2.1 (q, 2H), 2.35 (m, 1H), 3.16 (q, 2H), 3.55 (s, 3H), 6.0 (s, 1H), 6.9 (q, 1H), 7.0 (q, 1H), 7.26 (q, 1H), 7.5 (s, 1H), 7.9 (s, 1H).

### Example 8

### Compound H

52.2 g of TDI trimer was dissolved in 400 mL of anhydrous tetrahydrofuran (THF), and the solution was added to a mixture of 22.2 g of γ-ureido-propyltrimethoxysilane and 0.07 g of dibutyltin dilaurate (DBTDL). The resultant solution was stirred for 5 hs at room temperature under a dry environment. Subsequently, THF was removed with reduced pressure distillation and 70.7 g of compound H was obtained, with a yield of 95%. The compound H has a formula of

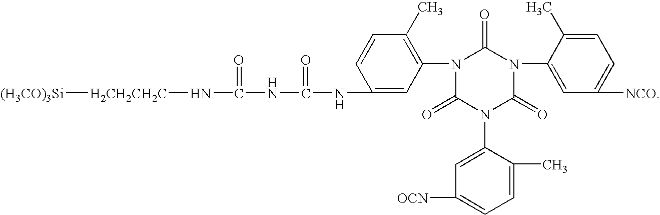

Elemental analysis of C₃₄H₃₆N₈O₁₀Si: measured value (calculated value) %: C, 54.73 (54.84); H, 4.75 (4.84); N, 14.96 (15.05); O, 21.39 (21.50); Si, 3.63 (3.76). ¹HNMR (δ/ppm): 2.1 (q, 2H), 2.35 (m, 1H), 3.55 (m, 3H), 4.19 (m, 2H), 6.0 (s, 1H), 6.9 (t, 1H), 7.0 (t, 1H), 7.26 (t, 1H), 7.5 (s, 1H), 7.9 (s, 1H), 10 (s, 1H).

### Example 9

### Compound I

52.2 g of TDI trimer was dissolved in 400 mL of anhydrous tetrahydrofuran (THF), and the solution was added to a mixture of 19.6 g of γ-mercapto-propyltrimethoxysilane and 0.07 g of dibutyltin dilaurate (DBTDL). The resultant solution was stirred for 8 hs at room temperature under a dry environment. Subsequently, THF was removed with reduced pressure distillation and 66.77 g of compound I was obtained, with a yield of 93%. The compound I has a formula of

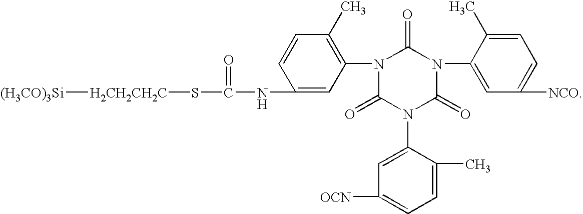

Elemental analysis of C₃₃H₃₄N₆O₉SSi: measured value (calculated value) %: C, 55.03 (55.15); H, 4.65 (4.74); N, 11.59 (11.70); O, 19.92 (20.05); S, 4.35 (4.46); Si, 3.79 (3.90). 1HNMR (δ/ppm): 2.35 (m, 1H), 2.8 (q, 2H), 3.2 (q, 2H), 3.55 (s, 1H), 6.9 (t, 1H), 7.02 (q, 1H), 7.26 (m, 1H), 7.5 (m, 1H), 7.9 (s, 1H), 8.0 (s, 1H).

### Example 10

### Compound J

52.2 g of TDI trimer was dissolved in 400 mL of anhydrous tetrahydrofuran (THF), and the solution was added to a mixture of 18.0 g of γ-hydroxyl-propyltrimethoxysilane and 0.07 g of dibutyltin dilaurate (DBTDL). The resultant solution was stirred for 5 hs at room temperature under a dry environment. Subsequently, THF was removed with reduced pressure distillation and 65.98 g of compound J was obtained, with a yield of 94%. The compound J has a formula of

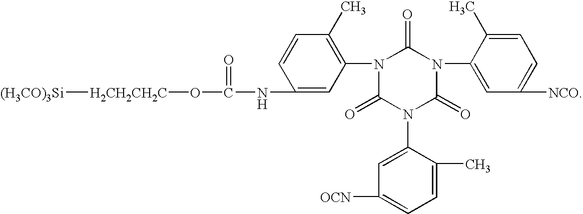

Elemental analysis of C₃₃H₃₄N₆O₁₀Si: measured value (calculated value) %: C, 56.39 (56.41); H, 4.69 (4.84); N, 11.83 (11.97); O, 22.68 (22.79); Si, 3.89 (3.99).

¹HNMR (δ/ppm): 0.58 (t, 2H), 1.6 (q, 2H), 2.35 (m, 1H), 3.55 (s, 3H), 4.08 (t, 2H), 6.9 (q, 1H), 7.0 (q, 1H), 7.26 (m, 1H), 7.5 (s, 1H), 7.9 (s, 1H), 8.0 (s, 1H).

### Example 11

### Compound K

52.2 g of TDI trimer was dissolved in 400 mL of anhydrous tetrahydrofuran (THF), and the solution was added to a mixture of 35.1 g of N″-[2-hydroxy-3-[(3-trimethoxylsilyl) propoxyl]propyl]-N,N,N′,N′-Tetra-methyl guanidine and 0.08 g of dibutyltin dilaurate (DBTDL). The resultant solution was stirred for 8 hs at room temperature under a dry environment. Subsequently, THF was removed with reduced pressure distillation and 78.57 g of compound K was obtained, with a yield of 90%. The compound K has a formula of

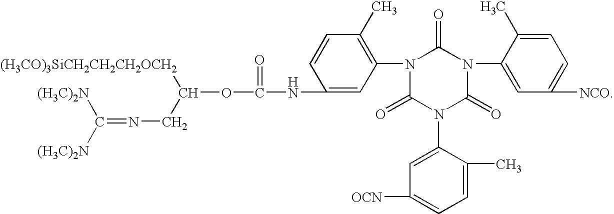

Elemental analysis of C₄₁H₅1N₉O₁₁Si: measured value (calculated value) %: C, 65.72 (65.75); H, 5.74 (5.84); N, 14.33 (14.43); O, 20.03 (20.16); Si, 3.09 (3.2). 1HNMR (δ/ppm): 1.4 (t, 2H), 1.57 (q, 2H), 1.96 (q, 2H), 2.35 (s, 1H), 2.47 (s, 3H), 3.55 (s, 3H), 4.0 (q, 2H), 5.0 (m, 2H), 6.9 (t, 1H), 7.0 (q, 1H), 7.5 (m, 1H), 7.9 (s, 1H), 8.0 (s, 1H).

### Example 12

### Compound L

104.4 g of TDI trimer was dissolved in 400 mL of anhydrous tetrahydrofuran (THF) and the solution was added to a mixture of 42 g of

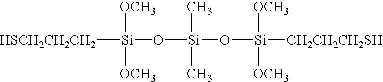

and 0.14 g of dibutyltin dilaurate (DBTDL). The resultant solution was stirred for 8 hs at room temperature under a dry environment. Subsequently, THF was removed with reduced pressure distillation and 135 g of compound L was obtained, with a yield of 92%. The compound L has a formula of

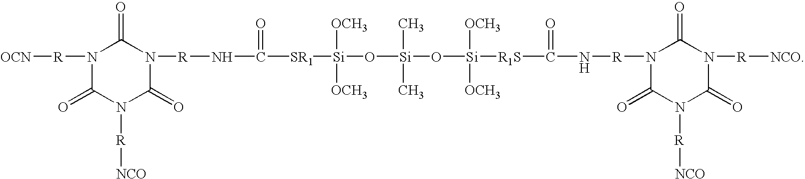

wherein R is

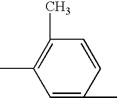

### and R₁ is —CH₂CH₂CH₂—.

Elemental analysis of C₆₆H₅₀N₁₂O₁₈S₂Si₂: measured value (calculated value) %: C, 55.76 (55.85); H, 3.44 (3.53); N, 11.74 (11.85); O, 20.22 (20.31); S, 4.42 (4.51); Si, 3.86 (3.95). 1HNMR (δ/ppm): 2.35 (m, 1H), 2.8 (q, 2H), 3.2 (q, 2H), 3.55 (s, 1H), 6.9 (t, 1H), 7.02 (q, 1H), 7.26 (m, 1H), 7.5 (m, 1H), 7.9 (s, 1H), 8.0 (s, 1H).

Other derivatives can be prepared by methods similar to the above mentioned. Some derivatives of the invention are listed in Tables 1 and 2.

In different compounds, the group represented by R has a formula of

| | |
|---|---|
| TDI₃ | 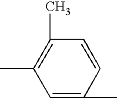 |
| NDI₃ | 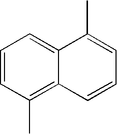 |
| IPDI₃ | 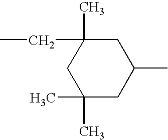 |
| HMDI₃ | 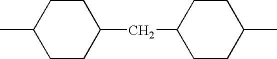 |
| MDI₃ | 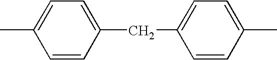 |
| HDI₃ | 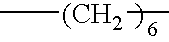 |
| TMCDI₃ | 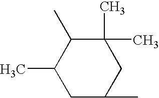 |

TABLE 1
Derivatives represented by formula (1) of the invention

| No. | R | X | R₁ | R² | R³ | a |
|---|---|---|---|---|---|---|
| 1 | TDI₃ | NH | CH₂CH₂CH₂ | CH₃ | CH₃O | 1 |
| 2 | TDI₃ | NH | CH₂CH₂CH₂ | CH₃ | CH₃O | 2 |
| 3 | TDI₃ | NHCH₂CH₂NH | CH₂CH₂CH₂ | CH₃ | CH₃O | 1 |
| 4 | TDI₃ | NHCH₂CH₂NH | CH₂CH₂CH₂ | CH₃ | CH₃O | 2 |
| 5 | TDI₃ | (C₆H₆)N | CH₂ | CH₃ | CH₃O | 1 |
| 6 | TDI₃ | (C₆H₆)N | CH₂ | CH₃ | CH₃CH₂O | 1 |
| 7 | TDI₃ | NHCH₂CH₂NHCH₂CH₂NH | CH₂CH₂CH₂ | CH₃ | CH₃O | 1 |
| 8 | TDI₃ | NHCH₂CH₂NHCH₂CH₂NH | CH₂CH₂CH₂ | CH₃ | CH₃O | 2 |
| 9 | TDI₃ | CH₃CH₂CH₂CH₂N | CH₂CH₂CH₂ | CH₃ | CH₃O | 1 |
| 10 | TDI₃ | CH₃CH₂CH₂CH₂N | CH₂CH₂CH₂ | CH₃ | CH₃O | 2 |
| 11 | TDI₃ | CH₃CH₂CH₂CH₂N | CH₂CH₂CH₂ | CH₃ | CH₃CH₂O | 1 |
| 12 | TDI₃ | NHCONH | CH₂CH₂CH₂ | CH₃ | CH₃O | 1 |
| 13 | TDI₃ | NHCONH | CH₂CH₂CH₂ | CH₃ | CH₃CH₂O | 1 |
| 14 | TDI₃ | NHCONHCH₂CH₂CH₂NH | CH₂CH₂CH₂ | CH₃ | CH₃O | 1 |
| 15 | TDI₃ | HS | CH₂CH₂CH₂ | CH₃ | CH₃O | 1 |
| 16 | TDI₃ | HS | CH₂CH₂CH₂ | CH₃ | CH₃O | 2 |
| 17 | TDI₃ | HS | CH₂CH₂CH₂ | CH₃ | CH₃CH₂O | 1 |
| 18 | TDI₃ | HO | CH₂CH₂CH₂ | CH₃ | CH₃O | 1 |
| 19 | TDI₃ | HO | CH₂CH₂CH₂ | CH₃ | CH₃CH₂O | 1 |
| 20 | TDI₃ | HO | CH₂CH₂CH₂ | CH₃ | CH₃O | 2 |
| 21 | MDI₃ | NH | CH₂CH₂CH₂ | CH₃ | CH₃O | 1 |
| 22 | MDI₃ | NH | CH₂CH₂CH₂ | CH₃ | CH₃O | 2 |
| 23 | MDI₃ | NHCH₂CH₂NH | CH₂CH₂CH₂ | CH₃ | CH₃O | 1 |
| 24 | MDI₃ | NHCH₂CH₂NH | CH₂CH₂CH₂ | CH₃ | CH₃O | 2 |
| 25 | MDI₃ | (C₆H₆)N | CH₂ | CH₃ | CH₃O | 1 |
| 26 | MDI₃ | (C₆H₆)N | CH₂ | CH₃ | CH₃CH₂O | 1 |
| 27 | MDI₃ | NHCH₂CH₂NHCH₂CH₂NH | CH₂CH₂CH₂ | CH₃ | CH₃O | 1 |
| 28 | MDI₃ | NHCH₂CH₂NHCH₂CH₂NH | CH₂CH₂CH₂ | CH₃ | CH₃O | 2 |
| 29 | MDI₃ | CH₃CH₂CH₂CH₂N | CH₂CH₂CH₂ | CH₃ | CH₃O | 1 |
| 30 | MDI₃ | CH₃CH₂CH₂CH₂N | CH₂CH₂CH₂ | CH₃ | CH₃O | 2 |
| 31 | MDI₃ | CH₃CH₂CH₂CH₂N | CH₂CH₂CH₂ | CH₃ | CH₃CH₂O | 1 |
| 32 | MDI₃ | NHCONH | CH₂CH₂CH₂ | CH₃ | CH₃O | 1 |
| 33 | MDI₃ | NHCONH | CH₂CH₂CH₂ | CH₃ | CH₃CH₂O | 1 |
| 34 | MDI₃ | NHCONHCH₂CH₂CH₂NH | CH₂CH₂CH₂ | CH₃ | CH₃O | 1 |
| 35 | MDI₃ | HS | CH₂CH₂CH₂ | CH₃ | CH₃O | 1 |
| 36 | MDI₃ | HS | CH₂CH₂CH₂ | CH₃ | CH₃O | 2 |
| 37 | MDI₃ | HS | CH₂CH₂CH₂ | CH₃ | CH₃CH₂O | 1 |
| 38 | MDI₃ | HO | CH₂CH₂CH₂ | CH₃ | CH₃O | 1 |
| 39 | MDI₃ | HO | CH₂CH₂CH₂ | CH₃ | CH₃CH₂O | 1 |
| 40 | MDI₃ | HO | CH₂CH₂CH₂ | CH₃ | CH₃O | 2 |
| 41 | NDI₃ | NH | CH₂CH₂CH₂ | CH₃ | CH₃O | 1 |
| 42 | NDI₃ | NH | CH₂CH₂CH₂ | CH₃ | CH₃O | 2 |
| 43 | NDI₃ | NHCH₂CH₂NH | CH₂CH₂CH₂ | CH₃ | CH₃O | 1 |
| 44 | NDI₃ | NHCH₂CH₂NH | CH₂CH₂CH₂ | CH₃ | CH₃O | 2 |
| 45 | NDI₃ | (C₆H₆)N | CH₂ | CH₃ | CH₃O | 1 |
| 46 | NDI₃ | (C₆H₆)N | CH₂ | CH₃ | CH₃CH₂O | 1 |
| 47 | NDI₃ | NHCH₂CH₂NHCH₂CH₂NH | CH₂CH₂CH₂ | CH₃ | CH₃O | 1 |
| 48 | NDI₃ | NHCH₂CH₂NHCH₂CH₂NH | CH₂CH₂CH₂ | CH₃ | CH₃O | 2 |
| 49 | NDI₃ | CH₃CH₂CH₂CH₂N | CH₂CH₂CH₂ | CH₃ | CH₃O | 1 |
| 50 | NDI₃ | CH₃CH₂CH₂CH₂N | CH₂CH₂CH₂ | CH₃ | CH₃O | 2 |
| 51 | NDI₃ | CH₃CH₂CH₂CH₂N | CH₂CH₂CH₂ | CH₃ | CH₃CH₂O | 1 |
| 52 | NDI₃ | NHCONH | CH₂CH₂CH₂ | CH₃ | CH₃O | 1 |
| 53 | NDI₃ | NHCONH | CH₂CH₂CH₂ | CH₃ | CH₃CH₂O | 1 |
| 54 | NDI₃ | NHCONHCH₂CH₂CH₂NH | CH₂CH₂CH₂ | CH₃ | CH₃O | 1 |
| 55 | NDI₃ | HS | CH₂CH₂CH₂ | CH₃ | CH₃O | 1 |
| 56 | NDI₃ | HS | CH₂CH₂CH₂ | CH₃ | CH₃O | 2 |
| 57 | NDI₃ | HS | CH₂CH₂CH₂ | CH₃ | CH₃CH₂O | 1 |
| 58 | NDI₃ | HO | CH₂CH₂CH₂ | CH₃ | CH₃O | 1 |
| 59 | NDI₃ | HO | CH₂CH₂CH₂ | CH₃ | CH₃CH₂O | 1 |
| 60 | NDI₃ | HO | CH₂CH₂CH₂ | CH₃ | CH₃O | 2 |
| 61 | HDI₃ | NH | CH₂CH₂CH₂ | CH₃ | CH₃O | 1 |
| 62 | HDI₃ | NH | CH₂CH₂CH₂ | CH₃ | CH₃O | 2 |
| 63 | HDI₃ | NHCH₂CH₂NH | CH₂CH₂CH₂ | CH₃ | CH₃O | 1 |
| 64 | HDI₃ | NHCH₂CH₂NH | CH₂CH₂CH₂ | CH₃ | CH₃O | 2 |
| 65 | HDI₃ | (C₆H₆)N | CH₂ | CH₃ | CH₃O | 1 |
| 66 | HDI₃ | (C₆H₆)N | CH₂ | CH₃ | CH₃CH₂O | 1 |
| 67 | HDI₃ | NHCH₂CH₂NHCH₂CH₂NH | CH₂CH₂CH₂ | CH₃ | CH₃O | 1 |
| 68 | HDI₃ | NHCH₂CH₂NHCH₂CH₂NH | CH₂CH₂CH₂ | CH₃ | CH₃O | 2 |
| 69 | HDI₃ | CH₃CH₂CH₂CH₂N | CH₂CH₂CH₂ | CH₃ | CH₃O | 1 |
| 70 | HDI₃ | CH₃CH₂CH₂CH₂N | CH₂CH₂CH₂ | CH₃ | CH₃O | 2 |
| 71 | HDI₃ | CH₃CH₂CH₂CH₂N | CH₂CH₂CH₂ | CH₃ | CH₃CH₂O | 1 |
| 72 | HDI₃ | NHCONH | CH₂CH₂CH₂ | CH₃ | CH₃O | 1 |
| 73 | HDI₃ | NHCONH | CH₂CH₂CH₂ | CH₃ | CH₃CH₂O | 1 |
| 74 | HDI₃ | NHCONHCH₂CH₂CH₂NH | CH₂CH₂CH₂ | CH₃ | CH₃O | 1 |
| 75 | HDI₃ | HS | CH₂CH₂CH₂ | CH₃ | CH₃O | 1 |
| 76 | HDI₃ | HS | CH₂CH₂CH₂ | CH₃ | CH₃O | 2 |
| 77 | HDI₃ | HS | CH₂CH₂CH₂ | CH₃ | CH₃CH₂O | 1 |
| 78 | HDI₃ | HO | CH₂CH₂CH₂ | CH₃ | CH₃O | 1 |
| 79 | HDI₃ | HO | CH₂CH₂CH₂ | CH₃ | CH₃CH₂O | 1 |
| 80 | HDI₃ | HO | CH₂CH₂CH₂ | CH₃ | CH₃O | 2 |
| 81 | IPDI₃ | NH | CH₂CH₂CH₂ | CH₃ | CH₃O | 1 |
| 82 | IPDI₃ | NH | CH₂CH₂CH₂ | CH₃ | CH₃O | 2 |
| 83 | IPDI₃ | NHCH₂CH₂NH | CH₂CH₂CH₂ | CH₃ | CH₃O | 1 |
| 84 | IPDI₃ | NHCH₂CH₂NH | CH₂CH₂CH₂ | CH₃ | CH₃O | 2 |
| 85 | IPDI₃ | (C₆H₆)N | CH₂ | CH₃ | CH₃O | 1 |
| 86 | IPDI₃ | (C₆H₆)N | CH₂ | CH₃ | CH₃CH₂O | 1 |
| 87 | IPDI₃ | NHCH₂CH₂NHCH₂CH₂NH | CH₂CH₂CH₂ | CH₃ | CH₃O | 1 |
| 88 | IPDI₃ | NHCH₂CH₂NHCH₂CH₂NH | CH₂CH₂CH₂ | CH₃ | CH₃O | 2 |
| 89 | IPDI₃ | CH₃CH₂CH₂CH₂N | CH₂CH₂CH₂ | CH₃ | CH₃O | 1 |
| 90 | IPDI₃ | CH₃CH₂CH₂CH₂N | CH₂CH₂CH₂ | CH₃ | CH₃O | 2 |
| 91 | IPDI₃ | CH₃CH₂CH₂CH₂N | CH₂CH₂CH₂ | CH₃ | | 1 |
| 92 | IPDI₃ | NHCONH | CH₂CH₂CH₂ | CH₃ | CH₃O | 1 |
| 93 | IPDI₃ | NHCONH | CH₂CH₂CH₂ | CH₃ | | 1 |
| 94 | IPDI₃ | NHCONHCH₂CH₂CH₂NH | CH₂CH₂CH₂ | CH₃ | CH₃O | 1 |
| 95 | IPDI₃ | HS | CH₂CH₂CH₂ | CH₃ | CH₃O | 1 |
| 96 | IPDI₃ | HS | CH₂CH₂CH₂ | CH₃ | CH₃O | 2 |
| 97 | IPDI₃ | HS | CH₂CH₂CH₂ | CH₃ | CH₃CH₂O | 1 |
| 98 | IPDI₃ | HO | CH₂CH₂CH₂ | CH₃ | CH₃O | 1 |
| 99 | IPDI₃ | HO | CH₂CH₂CH₂ | CH₃ | CH₃CH₂O | 1 |
| 100 | IPDI₃ | HO | CH₂CH₂CH₂ | CH₃ | CH₃O | 2 |
| 101 | TMCDI₃ | NH | CH₂CH₂CH₂ | CH₃ | CH₃O | 1 |
| 102 | TMCDI₃ | NH | CH₂CH₂CH₂ | CH₃ | CH₃O | 2 |
| 103 | TMCDI₃ | NHCH₂CH₂NH | CH₂CH₂CH₂ | CH₃ | CH₃O | 1 |
| 104 | TMCDI₃ | NHCH₂CH₂NH | CH₂CH₂CH₂ | CH₃ | CH₃O | 2 |
| 105 | TMCDI₃ | (C₆H₆)N | CH₂ | CH₃ | CH₃O | 1 |
| 106 | TMCDI₃ | (C₆H₆)N | CH₂ | CH₃ | CH₃CH₂O | 1 |
| 107 | TMCDI₃ | NHCH₂CH₂NHCH₂CH₂NH | CH₂CH₂CH₂ | CH₃ | CH₃O | 1 |
| 108 | TMCDI₃ | NHCH₂CH₂NHCH₂CH₂NH | CH₂CH₂CH₂ | CH₃ | CH₃O | 2 |
| 109 | TMCDI₃ | CH₃CH₂CH₂CH₂N | CH₂CH₂CH₂ | CH₃ | CH₃O | 1 |
| 110 | TMCDI₃ | CH₃CH₂CH₂CH₂N | CH₂CH₂CH₂ | CH₃ | CH₃O | 2 |
| 111 | TMCDI₃ | CH₃CH₂CH₂CH₂N | CH₂CH₂CH₂ | CH₃ | CH₃CH₂O | 1 |
| 112 | TMCDI₃ | NHCONH | CH₂CH₂CH₂ | CH₃ | CH₃O | 1 |
| 113 | TMCDI₃ | NHCONH | CH₂CH₂CH₂ | CH₃ | CH₃CH₂O | 1 |
| 114 | TMCDI₃ | NHCONHCH₂CH₂CH₂NH | CH₂CH₂CH₂ | CH₃ | CH₃O | 1 |
| 115 | TMCDI₃ | HS | CH₂CH₂CH₂ | CH₃ | CH₃O | 1 |
| 116 | TMCDI₃ | HS | CH₂CH₂CH₂ | CH₃ | CH₃O | 2 |
| 117 | TMCDI₃ | HS | CH₂CH₂CH₂ | CH₃ | CH₃CH₂O | 1 |
| 118 | TMCDI₃ | HO | CH₂CH₂CH₂ | CH₃ | CH₃O | 1 |
| 119 | TMCDI₃ | HO | CH₂CH₂CH₂ | CH₃ | CH₃CH₂O | 1 |
| 120 | TMCDI₃ | HO | CH₂CH₂CH₂ | CH₃ | CH₃O | 2 |
| 121 | HMDI₃ | NH | CH₂CH₂CH₂ | CH₃ | CH₃O | 1 |
| 122 | HMDI₃ | NH | CH₂CH₂CH₂ | CH₃ | CH₃O | 2 |
| 123 | HMDI₃ | NHCH₂CH₂NH | CH₂CH₂CH₂ | CH₃ | CH₃O | 1 |
| 124 | HMDI₃ | NHCH₂CH₂NH | CH₂CH₂CH₂ | CH₃ | CH₃O | 2 |
| 125 | HMDI₃ | (C₆H₆)N | CH₂ | CH₃ | CH₃O | 1 |
| 126 | HMDI₃ | (C₆H₆)N | CH₂ | CH₃ | CH₃CH₂O | 1 |
| 127 | HMDI₃ | NHCH₂CH₂NHCH₂CH₂NH | CH₂CH₂CH₂ | CH₃ | CH₃O | 1 |
| 128 | HMDI₃ | NHCH₂CH₂NHCH₂CH₂NH | CH₂CH₂CH₂ | CH₃ | CH₃O | 2 |
| 129 | HMDI₃ | CH₃CH₂CH₂CH₂N | CH₂CH₂CH₂ | CH₃ | CH₃O | 1 |
| 130 | HMDI₃ | CH₃CH₂CH₂CH₂N | CH₂CH₂CH₂ | CH₃ | CH₃O | 2 |
| 131 | HMDI₃ | CH₃CH₂CH₂CH₂N | CH₂CH₂CH₂ | CH₃ | CH₃CH₂O | 1 |
| 132 | HMDI₃ | NHCONH | CH₂CH₂CH₂ | CH₃ | CH₃O | 1 |
| 133 | HMDI₃ | NHCONH | CH₂CH₂CH₂ | CH₃ | CH₃CH₂O | 1 |
| 134 | HMDI₃ | NHCONHCH₂CH₂CH₂NH | CH₂CH₂CH₂ | CH₃ | CH₃O | 1 |
| 135 | HMDI₃ | HS | CH₂CH₂CH₂ | CH₃ | CH₃O | 1 |
| 136 | HMDI₃ | HS | CH₂CH₂CH₂ | CH₃ | CH₃O | 2 |
| 137 | HMDI₃ | HS | CH₂CH₂CH₂ | CH₃ | CH₃CH₂O | 1 |
| 138 | HMDI₃ | HO | CH₂CH₂CH₂ | CH₃ | CH₃O | 1 |
| 139 | HMDI₃ | HO | CH₂CH₂CH₂ | CH₃ | CH₃CH₂O | 1 |
| 140 | HMDI₃ | HO | CH₂CH₂CH₂ | CH₃ | CH₃O | 2 |

TABLE 2
Derivatives represented by formula (2) of the invention

| No. | R | X | R₁ | R₂ = R₄ | R₃ = R₅ | m |
|---|---|---|---|---|---|---|
| 141 | TDI₃ | NH | CH₂CH₂CH₂ | CH₃ | CH₃O | 1-10 |
| 142 | TDI₃ | NH | CH₂CH₂CH₂ | CH₃O | CH₃ | 10-20 |
| 143 | TDI₃ | NH | CH₂CH₂CH₂ | CH₃ | CH₃O | 20-30 |
| 144 | TDI₃ | NHCH₂CH₂NH | CH₂CH₂CH₂ | CH₃ | CH₃O | 1-10 |
| 145 | TDI₃ | NHCH₂CH₂NH | CH₂CH₂CH₂ | CH₃O | CH₃ | 10-20 |
| 146 | TDI₃ | NHCH₂CH₂NH | CH₂CH₂CH₂ | CH₃ | CH₃O | 20-30 |
| 147 | TDI₃ | (C₆H₆)N | CH₂ | CH₃ | CH₃O | 1-10 |
| 148 | TDI₃ | (C₆H₆)N | CH₂ | CH₃O | CH₃ | 10-20 |
| 149 | TDI₃ | (C₆H₆)N | CH₂ | CH₃ | CH₃O | 20-30 |
| 150 | TDI₃ | NHCH₂CH₂NHCH₂CH₂NH | CH₂CH₂CH₂ | CH₃ | CH₃O | 1-10 |
| 151 | TDI₃ | NHCH₂CH₂NHCH₂CH₂NH | CH₂CH₂CH₂ | CH₃O | CH₃ | 10-20 |
| 152 | TDI₃ | NHCH₂CH₂NHCH₂CH₂NH | CH₂CH₂CH₂ | CH₃ | CH₃O | 20-30 |
| 153 | TDI₃ | CH₃CH₂CH₂CH₂N | CH₂CH₂CH₂ | CH₃ | CH₃O | 1-10 |
| 154 | TDI₃ | CH₃CH₂CH₂CH₂N | CH₂CH₂CH₂ | CH₃O | CH₃ | 10-20 |
| 155 | TDI₃ | CH₃CH₂CH₂CH₂N | CH₂CH₂CH₂ | CH₃ | CH₃O | 20-30 |
| 156 | TDI₃ | NHCONH | CH₂CH₂CH₂ | CH₃ | CH₃O | 1-10 |
| 157 | TDI₃ | NHCONH | CH₂CH₂CH₂ | CH₃O | CH₃ | 10-20 |
| 158 | TDI₃ | NHCONH | CH₂CH₂CH₂ | CH₃ | CH₃O | 20-30 |
| 159 | TDI₃ | HS | CH₂CH₂CH₂ | CH₃ | CH₃O | 1-10 |
| 160 | TDI₃ | HS | CH₂CH₂CH₂ | CH₃O | CH₃ | 10-20 |
| 161 | TDI₃ | HS | CH₂CH₂CH₂ | CH₃ | CH₃O | 20-30 |
| 162 | TDI₃ | HO | CH₂CH₂CH₂ | CH₃ | CH₃O | 1-10 |
| 163 | TDI₃ | HO | CH₂CH₂CH₂ | CH₃O | CH₃ | 10-20 |
| 164 | TDI₃ | HO | CH₂CH₂CH₂ | CH₃ | CH₃O | 20-30 |
| 165 | MDI₃ | NH | CH₂CH₂CH₂ | CH₃ | CH₃O | 1-10 |
| 166 | MDI₃ | NH | CH₂CH₂CH₂ | CH₃O | CH₃ | 10-20 |
| 167 | MDI₃ | NH | CH₂CH₂CH₂ | CH₃ | CH₃O | 20-30 |
| 168 | MDI₃ | NHCH₂CH₂NH | CH₂CH₂CH₂ | CH₃O | CH₃ | 1-10 |
| 169 | MDI₃ | NHCH₂CH₂NH | CH₂CH₂CH₂ | CH₃ | CH₃O | 10-20 |
| 170 | MDI₃ | NHCH₂CH₂NH | CH₂CH₂CH₂ | CH₃O | CH₃ | 20-30 |
| 171 | MDI₃ | (C₆H₆)N | CH₂ | CH₃ | CH₃O | 1-10 |
| 172 | MDI₃ | (C₆H₆)N | CH₂ | CH₃O | CH₃ | 10-20 |
| 173 | MDI₃ | (C₆H₆)N | CH₂ | CH₃ | CH₃O | 20-30 |
| 174 | MDI₃ | NHCH₂CH₂NHCH₂CH₂NH | CH₂CH₂CH₂ | CH₃ | CH₃O | 1-10 |
| 175 | MDI₃ | NHCH₂CH₂NHCH₂CH₂NH | CH₂CH₂CH₂ | CH₃O | CH₃ | 10-20 |
| 176 | MDI₃ | NHCH₂CH₂NHCH₂CH₂NH | CH₂CH₂CH₂ | CH₃ | CH₃O | 20-30 |
| 177 | MDI₃ | CH₃CH₂CH₂CH₂N | CH₂CH₂CH₂ | CH₃O | CH₃ | 1-10 |
| 178 | MDI₃ | CH₃CH₂CH₂CH₂N | CH₂CH₂CH₂ | CH₃ | CH₃O | 10-20 |
| 179 | MDI₃ | CH₃CH₂CH₂CH₂N | CH₂CH₂CH₂ | CH₃O | CH₃ | 20-30 |
| 180 | MDI₃ | NHCONH | CH₂CH₂CH₂ | CH₃ | CH₃O | 1-10 |
| 181 | MDI₃ | NHCONH | CH₂CH₂CH₂ | CH₃O | CH₃ | 10-20 |
| 182 | MDI₃ | NHCONH | CH₂CH₂CH₂ | CH₃ | CH₃O | 20-30 |
| 183 | MDI₃ | HS | CH₂CH₂CH₂ | CH₃O | CH₃ | 1-10 |
| 184 | MDI₃ | HS | CH₂CH₂CH₂ | CH₃ | CH₃O | 10-20 |
| 185 | MDI₃ | HS | CH₂CH₂CH₂ | CH₃O | CH₃ | 20-30 |
| 186 | MDI₃ | HO | CH₂CH₂CH₂ | CH₃ | CH₃O | 1-10 |
| 187 | MDI₃ | HO | CH₂CH₂CH₂ | CH₃O | CH₃ | 10-20 |
| 188 | MDI₃ | HO | CH₂CH₂CH₂ | CH₃ | CH₃O | 20-30 |
| 189 | NDI₃ | NH | CH₂CH₂CH₂ | CH₃ | CH₃O | 1-10 |
| 190 | NDI₃ | NH | CH₂CH₂CH₂ | CH₃O | CH₃ | 10-20 |
| 191 | NDI₃ | NH | CH₂CH₂CH₂ | CH₃ | CH₃O | 20-30 |
| 192 | NDI₃ | NHCH₂CH₂NH | CH₂CH₂CH₂ | CH₃O | CH₃ | 1-10 |
| 193 | NDI₃ | NHCH₂CH₂NH | CH₂CH₂CH₂ | CH₃ | CH₃O | 10-20 |
| 194 | NDI₃ | NHCH₂CH₂NH | CH₂CH₂CH₂ | CH₃O | CH₃ | 20-30 |
| 195 | NDI₃ | (C₆H₆)N | CH₂ | CH₃ | CH₃O | 1-10 |
| 196 | NDI₃ | (C₆H₆)N | CH₂ | CH₃O | CH₃ | 10-20 |
| 197 | NDI₃ | (C₆H₆)N | CH₂ | CH₃ | CH₃O | 20-30 |
| 198 | NDI₃ | NHCH₂CH₂NHCH₂CH₂NH | CH₂CH₂CH₂ | CH₃O | CH₃ | 1-10 |
| 199 | NDI₃ | NHCH₂CH₂NHCH₂CH₂NH | CH₂CH₂CH₂ | CH₃ | CH₃O | 10-20 |
| 200 | NDI₃ | NHCH₂CH₂NHCH₂CH₂NH | CH₂CH₂CH₂ | CH₃O | CH₃ | 20-30 |
| 201 | NDI₃ | CH₃CH₂CH₂CH₂N | CH₂CH₂CH₂ | CH₃ | CH₃O | 1-10 |
| 202 | NDI₃ | CH₃CH₂CH₂CH₂N | CH₂CH₂CH₂ | CH₃O | CH₃ | 10-20 |
| 203 | NDI₃ | CH₃CH₂CH₂CH₂N | CH₂CH₂CH₂ | CH₃ | CH₃O | 20-30 |
| 204 | NDI₃ | NHCONH | CH₂CH₂CH₂ | CH₃O | CH₃ | 1-10 |
| 205 | NDI₃ | NHCONH | CH₂CH₂CH₂ | CH₃ | CH₃O | 10-20 |
| 206 | NDI₃ | NHCONH | CH₂CH₂CH₂ | CH₃O | CH₃ | 20-30 |
| 207 | NDI₃ | HS | CH₂CH₂CH₂ | CH₃ | CH₃O | 1-10 |
| 208 | NDI₃ | HS | CH₂CH₂CH₂ | CH₃O | CH₃ | 10-20 |
| 209 | NDI₃ | HS | CH₂CH₂CH₂ | CH₃ | CH₃O | 20-30 |
| 210 | NDI₃ | HO | CH₂CH₂CH₂ | CH₃O | CH₃ | 1-10 |
| 211 | NDI₃ | HO | CH₂CH₂CH₂ | CH₃ | CH₃O | 10-20 |
| 212 | NDI₃ | HO | CH₂CH₂CH₂ | CH₃O | CH₃ | 20-30 |
| 213 | HDI₃ | NH | CH₂CH₂CH₂ | CH₃ | CH3O | 1-10 |
| 214 | HDI₃ | NH | CH₂CH₂CH₂ | CH₃O | CH₃ | 10-20 |
| 215 | HDI₃ | NH | CH₂CH₂CH₂ | CH₃ | CH₃O | 20-30 |
| 216 | HDI₃ | NHCH₂CH₂NH | CH₂CH₂CH₂ | CH₃O | CH₃ | 1-10 |
| 217 | HDI₃ | NHCH₂CH₂NH | CH₂CH₂CH₂ | CH₃ | CH₃O | 10-20 |
| 218 | HDI₃ | NHCH₂CH₂NH | CH₂CH₂CH₂ | CH₃O | CH₃ | 20-30 |
| 219 | HDI₃ | (C₆H₆)N | CH₂ | CH₃ | CH₃O | 1-10 |
| 220 | HDI₃ | (C₆H₆)N | CH₂ | CH₃O | CH₃ | 10-20 |
| 221 | HDI₃ | (C₆H₆)N | CH₂ | CH₃ | CH₃O | 20-30 |
| 222 | HDI₃ | NHCH₂CH₂NHCH₂CH₂NH | CH₂CH₂CH₂ | CH₃O | CH₃ | 1-10 |
| 223 | HDI₃ | NHCH₂CH₂NHCH₂CH₂NH | CH₂CH₂CH₂ | CH₃ | CH₃O | 10-20 |
| 224 | HDI₃ | NHCH₂CH₂NHCH₂CH₂NH | CH₂CH₂CH₂ | CH₃O | CH₃ | 20-30 |
| 225 | HDI₃ | CH₃CH₂CH₂CH₂N | CH₂CH₂CH₂ | CH₃ | CH₃O | 1-10 |
| 226 | HDI₃ | CH₃CH₂CH₂CH₂N | CH₂CH₂CH₂ | CH₃O | CH₃ | 10-20 |
| 227 | HDI₃ | CH₃CH₂CH₂CH₂N | CH₂CH₂CH₂ | CH₃ | CH₃O | 20-30 |
| 228 | HDI₃ | NHCONH | CH₂CH₂CH₂ | CH₃O | CH₃ | 1-10 |
| 229 | HDI₃ | NHCONH | CH₂CH₂CH₂ | CH₃ | CH₃O | 10-20 |
| 230 | HDI₃ | NHCONH | CH₂CH₂CH₂ | CH₃O | CH₃ | 20-30 |
| 231 | HDI₃ | HS | CH₂CH₂CH₂ | CH₃ | CH₃O | 1-10 |
| 232 | HDI₃ | HS | CH₂CH₂CH₂ | CH₃O | CH₃ | 10-20 |
| 233 | HDI₃ | HS | CH₂CH₂CH₂ | CH₃ | CH₃O | 20-30 |
| 234 | HDI₃ | OH | CH₂CH₂CH₂ | CH₃O | CH₃ | 1-10 |
| 235 | HDI₃ | OH | CH₂CH₂CH₂ | CH₃ | CH₃O | 10-20 |
| 236 | HDI₃ | OH | CH₂CH₂CH₂ | CH₃O | CH₃ | 20-30 |
| 237 | IPDI₃ | NH | CH₂CH₂CH₂ | CH₃ | CH₃O | 1-10 |
| 238 | IPDI₃ | NH | CH₂CH₂CH₂ | CH₃O | CH₃ | 10-20 |
| 239 | IPDI₃ | NH | CH₂CH₂CH₂ | CH₃ | CH₃O | 20-30 |
| 240 | IPDI₃ | NHCH₂CH₂NH | CH₂CH₂CH₂ | CH₃O | CH₃ | 1-10 |
| 241 | IPDI₃ | NHCH₂CH₂NH | CH₂CH₂CH₂ | CH₃ | CH₃O | 10-20 |
| 242 | IPDI₃ | NHCH₂CH₂NH | CH₂CH₂CH₂ | CH₃O | CH₃ | 20-30 |
| 243 | IPDI₃ | (C₆H₆)N | CH₂ | CH₃ | CH₃O | 1-10 |
| 244 | IPDI₃ | (C₆H₆)N | CH₂ | CH₃O | CH₃ | 10-20 |
| 245 | IPDI₃ | (C₆H₆)N | CH₂ | CH₃ | CH₃O | 20-30 |
| 246 | IPDI₃ | NHCH₂CH₂NHCH₂CH₂NH | CH₂CH₂CH₂ | CH₃O | CH₃ | 1-10 |
| 247 | IPDI₃ | NHCH₂CH₂NHCH₂CH₂NH | CH₂CH₂CH₂ | CH₃ | CH₃O | 10-20 |
| 248 | IPDI₃ | NHCH₂CH₂NHCH₂CH₂NH | CH₂CH₂CH₂ | CH₃O | CH₃ | 20-30 |
| 249 | IPDI₃ | CH₃CH₂CH₂CH₂N | CH₂CH₂CH₂ | CH₃ | CH₃O | 1-10 |
| 250 | IPDI₃ | CH₃CH₂CH₂CH₂N | CH₂CH₂CH₂ | CH₃O | CH₃ | 10-20 |
| 251 | IPDI₃ | CH₃CH₂CH₂CH₂N | CH₂CH₂CH₂ | CH₃ | CH₃O | 20-30 |
| 252 | IPDI₃ | NHCONH | CH₂CH₂CH₂ | CH₃O | CH₃ | 1-10 |
| 253 | IPDI₃ | NHCONH | CH₂CH₂CH₂ | CH₃ | CH₃O | 10-20 |
| 254 | IPDI₃ | NHCONH | CH₂CH₂CH₂ | CH₃O | CH₃ | 20-30 |
| 255 | IPDI₃ | HS | CH₂CH₂CH₂ | CH₃ | CH₃O | 1-10 |
| 256 | IPDI₃ | HS | CH₂CH₂CH₂ | CH₃O | CH₃ | 10-20 |
| 257 | IPDI₃ | HS | CH₂CH₂CH₂ | CH₃ | CH₃O | 20-30 |
| 258 | IPDI₃ | OH | CH₂CH₂CH₂ | CH₃O | CH₃ | 1-10 |
| 259 | IPDI₃ | OH | CH₂CH₂CH₂ | CH₃ | CH₃O | 10-20 |
| 260 | IPDI₃ | OH | CH₂CH₂CH₂ | CH₃O | CH₃ | 20-30 |
| 261 | TMCDI₃ | NH | CH₂CH₂CH₂ | CH₃ | CH₃O | 1-10 |
| 262 | TMCDI₃ | NH | CH₂CH₂CH₂ | CH₃O | CH₃ | 10-20 |
| 263 | TMCDI₃ | NH | CH₂CH₂CH₂ | CH₃ | CH₃O | 20-30 |
| 264 | TMCDI₃ | NHCH₂CH₂NH | CH₂CH₂CH₂ | CH₃O | CH₃ | 1-10 |
| 265 | TMCDI₃ | NHCH₂CH₂NH | CH₂CH₂CH₂ | CH₃ | CH₃O | 10-20 |
| 266 | TMCDI₃ | NHCH₂CH₂NH | CH₂CH₂CH₂ | CH₃O | CH₃ | 20-30 |
| 267 | TMCDI₃ | (C₆H₆)N | CH₂ | CH₃ | CH₃O | 1-10 |
| 268 | TMCDI₃ | (C₆H₆)N | CH₂ | CH₃O | CH₃ | 10-20 |
| 269 | TMCDI₃ | (C₆H₆)N | CH₂ | CH₃ | CH₃O | 20-30 |
| 270 | TMCDI₃ | NHCH₂CH₂NHCH₂CH₂NH | CH₂CH₂CH₂ | CH₃O | CH₃ | 1-10 |
| 271 | TMCDI₃ | NHCH₂CH₂NHCH₂CH₂NH | CH₂CH₂CH₂ | CH₃ | CH₃O | 10-20 |
| 272 | TMCDI₃ | NHCH₂CH₂NHCH₂CH₂NH | CH₂CH₂CH₂ | CH₃O | CH₃ | 20-30 |
| 273 | TMCDI₃ | CH₃CH₂CH₂CH₂N | CH₂CH₂CH₂ | CH₃ | CH₃O | 1-10 |
| 274 | TMCDI₃ | CH₃CH₂CH₂CH₂N | CH₂CH₂CH₂ | CH₃O | CH₃ | 10-20 |
| 275 | TMCDI₃ | CH₃CH₂CH₂CH₂N | CH₂CH₂CH₂ | CH₃ | CH₃O | 20-30 |
| 276 | TMCDI₃ | NHCONH | CH₂CH₂CH₂ | CH₃O | CH₃ | 1-10 |
| 277 | TMCDI₃ | NHCONH | CH₂CH₂CH₂ | CH₃ | CH₃O | 10-20 |
| 278 | TMCDI₃ | NHCONH | CH₂CH₂CH₂ | CH₃O | CH₃ | 20-30 |
| 279 | TMCDI₃ | HS | CH₂CH₂CH₂ | CH₃ | CH₃O | 1-10 |
| 280 | TMCDI₃ | HS | CH₂CH₂CH₂ | CH₃O | CH₃ | 10-20 |
| 281 | TMCDI₃ | HS | CH₂CH₂CH₂ | CH₃ | CH₃O | 20-30 |
| 282 | TMCDI₃ | HO | CH₂CH₂CH₂ | CH₃O | CH₃ | 1-10 |
| 283 | TMCDI₃ | HO | CH₂CH₂CH₂ | CH₃ | CH₃O | 10-20 |
| 284 | TMCDI₃ | HO | CH₂CH₂CH₂ | CH₃O | CH₃ | 20-30 |
| 285 | HMDI₃ | NH | CH₂CH₂CH₂ | CH₃ | CH₃O | 1-10 |
| 286 | HMDI₃ | NH | CH₂CH₂CH₂ | CH₃O | CH₃ | 10-20 |
| 287 | HMDI₃ | NH | CH₂CH₂CH₂ | CH₃ | CH₃O | 20-30 |
| 288 | HMDI₃ | NHCH₂CH₂NH | CH₂CH₂CH₂ | CH₃O | CH₃ | 1-10 |
| 289 | HMDI₃ | NHCH₂CH₂NH | CH₂CH₂CH₂ | CH₃ | CH₃O | 10-20 |
| 290 | HMDI₃ | NHCH₂CH₂NH | CH₂CH₂CH₂ | CH₃O | CH₃ | 20-30 |
| 291 | HMDI₃ | (C₆H₆)N | CH₂ | CH₃ | CH₃O | 1-10 |
| 292 | HMDI₃ | (C₆H₆)N | CH₂ | CH₃O | CH₃ | 10-20 |
| 293 | HMDI₃ | (C₆H₆)N | CH₂ | CH₃ | CH₃O | 20-30 |
| 294 | HMDI₃ | NHCH₂CH₂NHCH₂CH₂NH | CH₂CH₂CH₂ | CH₃O | CH₃ | 1-10 |
| 295 | HMDI₃ | NHCH₂CH₂NHCH₂CH₂NH | CH₂CH₂CH₂ | CH₃ | CH₃O | 10-20 |
| 296 | HMDI₃ | NHCH₂CH₂NHCH₂CH₂NH | CH₂CH₂CH₂ | CH₃O | CH₃ | 20-30 |
| 297 | HMDI₃ | CH₃CH₂CH₂CH₂N | CH₂CH₂CH₂ | CH₃ | CH₃O | 1-10 |
| 298 | HMDI₃ | CH₃CH₂CH₂CH₂N | CH₂CH₂CH₂ | CH₃O | CH₃ | 10-20 |
| 299 | HMDI₃ | CH₃CH₂CH₂CH₂N | CH₂CH₂CH₂ | CH₃ | CH₃O | 20-30 |
| 300 | HMDI₃ | NHCONH | CH₂CH₂CH₂ | CH₃O | CH₃ | 1-10 |
| 301 | HMDI₃ | NHCONH | CH₂CH₂CH₂ | CH₃ | CH₃O | 10-20 |
| 302 | HMDI₃ | NHCONH | CH₂CH₂CH₂ | CH₃O | CH₃ | 20-30 |
| 303 | HMDI₃ | HS | CH₂CH₂CH₂ | CH₃ | CH₃O | 1-10 |
| 304 | HMDI₃ | HS | CH₂CH₂CH₂ | CH₃O | CH₃ | 10-20 |
| 305 | HMDI₃ | HS | CH₂CH₂CH₂ | CH₃ | CH₃O | 20-30 |
| 306 | HMDI₃ | HO | CH₂CH₂CH₂ | CH₃O | CH₃ | 1-10 |
| 307 | HMDI₃ | HO | CH₂CH₂CH₂ | CH₃ | CH₃O | 10-20 |
| 308 | HMDI₃ | HO | CH₂CH₂CH₂ | CH₃O | CH₃ | 20-30 |

### Example 13

To a four necked flask (500 mL) equipped with a thermometer, a reflux condenser, a stirrer, and a funnel, 128 g of the compound 89, 46.5 g of polycarbonate diol (Mn=1000), 6 g of polyethyleneglycol adipate (Mn=2000), 6 g of dimethyopropionic acid, 14 g of N-methylpyrrolidone, 0.4 g of DBTDL, and 10 g of acetone were separately added. The mixture was allowed to react at 70° C. until the amount of free isocyanate was less than 0.5 weight %, and thereby a polyurethane prepolymer was obtained. The prepolymer was cooled to 40° C., and then 6 g of triethylamine was added dropwise for neutralizing, 120 g of deionized water added for shearing, and 2 g of ethyldiamine added for chain extension. Finally, acetone was removed under reduced pressure distillation to yield a polyurethane emulsion with solid content of 42 weight %.

### Example 14

To a four necked flask (500 mL) equipped with a thermometer, a reflux condenser, a stirrer, and a funnel, 32 g of IPDI, 46.5 g of polycarbonate diol (Mn=1000), 6 g of polyethyleneglycol adipate (Mn=2000), 6 g of dimethyopropionic acid, 14 g of N-methylpyrrolidone, 0.4 g of DBTDL, and 10 g of acetone were separately added. The mixture was allowed to react at 70° C. until the amount of free isocyanate was less than 0.5 weight %, and thereby a polyurethane prepolymer was obtained. The prepolymer was cooled to 40° C., and then 6 g of triethylamine was added dropwise for neutralizing, 120 g of deionized water added for shearing, and 2 g of ethyldiamine added for chain extension. Finally, acetone was removed under reduced pressure distillation to yield a polyurethane emulsion with solid content of 40 weight %.

### Example 15

### Performance Measurement

To evaluate the effectiveness of polyurethane (PU), epoxy resin, polymethacrylate (PMA), polyacrylamide (PAM), or phenolic resingloss prepared by isocyanate trimers modified with silane or functional polysiloxane, the gross, contact angle, surface drying time (h), adhesion, hardness, and flexibility of a coating of waterborne polyurethane prepared by isocyanate trimers modified with silane or functional polysiloxane were measured, and part of results were listed in Table 3.

TABLE 3
Performance index of waterborne polyurethane prepared by isocyanate
trimer modified with silane or functional polysiloxane

| | | | | Surface | | | |
|---|---|---|---|---|---|---|---|
| | | | Contact | drying time | | | Flexibility |
| No. | Si-compound | Gloss | angle(θ) | (min, 25° C.) | Hardness | Adhesion | (mm) |
| 309(b) | — | 82 | 55 | 60 | 0.4 | 3 | 4 |
| 310 | 81 | 90 | 72 | 25 | 0.6 | 1 | 2 |
| 311 | 82 | 90 | 72 | 24 | 0.6 | 1 | 2 |
| 312 | 83 | 90 | 72 | 24 | 0.6 | 1 | 2 |
| 313 | 84 | 92 | 72 | 24 | 0.6 | 1 | 2 |
| 314 | 85 | 91 | 70 | 24 | 0.6 | 2 | 2 |
| 315 | 86 | 90 | 70 | 23 | 0.6 | 2 | 2 |
| 316 | 87 | 90 | 71 | 22 | 0.6 | 1 | 2 |
| 317 | 88 | 90 | 71 | 23 | 0.6 | 1 | 2 |
| 318 | 89 | 90 | 71 | 24 | 0.6 | 1 | 2 |
| 319 | 90 | 91 | 72 | 20 | 0.6 | 1 | 2 |
| 320 | 91 | 93 | 72 | 20 | 0.6 | 1 | 2 |
| 321 | 92 | 93 | 72 | 19 | 0.6 | 1 | 2 |
| 322 | 93 | 94 | 72 | 19 | 0.6 | 1 | 2 |
| 323 | 94 | 94 | 72 | 19 | 0.6 | 1 | 2 |
| 324 | 95 | 90 | 72 | 22 | 0.6 | 1 | 2 |
| 325 | 96 | 90 | 72 | 22 | 0.6 | 1 | 2 |
| 326 | 97 | 90 | 72 | 22 | 0.6 | 1 | 2 |
| 327 | 98 | 90 | 72 | 24 | 0.6 | 1 | 2 |
| 328 | 99 | 90 | 71 | 25 | 0.6 | 2 | 2 |
| 329 | 100 | 90 | 71 | 25 | 0.6 | 2 | 2 |
| 330 | 237 | 98 | 77 | 21 | 0.7 | 1 | 1 |
| 331 | 238 | 97 | 77 | 21 | 0.7 | 0 | 1 |
| 332 | 239 | 98 | 77 | 22 | 0.7 | 0 | 1 |
| 333 | 240 | 99 | 77 | 19 | 0.7 | 1 | 1 |
| 334 | 241 | 98 | 77 | 19 | 0.7 | 1 | 1 |
| 335 | 242 | 98 | 78 | 19 | 0.7 | 0 | 1 |
| 336 | 243 | 97 | 78 | 20 | 0.7 | 1 | 1 |
| 337 | 244 | 98 | 78 | 20 | 0.7 | 1 | 1 |
| 338 | 245 | 99 | 78 | 20 | 0.7 | 1 | 1 |
| 339 | 246 | 98 | 78 | 20 | 0.7 | 1 | 1 |
| 340 | 247 | 97 | 78 | 20 | 0.7 | 0 | 1 |
| 341 | 248 | 99 | 78 | 20 | 0.7 | 0 | 1 |
| 342 | 249 | 97 | 78 | 19 | 0.7 | 1 | 1 |
| 343 | 250 | 97 | 78 | 21 | 0.7 | 0 | 1 |
| 344 | 251 | 97 | 78 | 21 | 0.7 | 0 | 1 |
| 345 | 252 | 98 | 78 | 21 | 0.7 | 1 | 1 |
| 346 | 253 | 98 | 78 | 22 | 0.7 | 0 | 1 |
| 347 | 254 | 98 | 77 | 22 | 0.7 | 0 | 1 |
| 348 | 255 | 99 | 77 | 21 | 0.7 | 1 | 1 |
| 349 | 256 | 98 | 78 | 21 | 0.7 | 0 | 1 |
| 350 | 257 | 99 | 77 | 21 | 0.7 | 0 | 1 |
| 351 | 258 | 98 | 77 | 21 | 0.7 | 1 | 1 |
| 352 | 259 | 99 | 77 | 22 | 0.7 | 0 | 1 |

The invention provides an isocyanate trimer modified with silane or functional polysiloxane and a method preparing the same. Waterborne polyurethane prepared by the modified isocyanate trimer has higher gloss, larger contact angle, greater hardness, drying faster, better adhesion, and better flexibility.

While particular embodiments of the invention have been shown and described, it will be obvious to those skilled in the art that changes and modifications may be made without departing from the invention in its broader aspects, and therefore, the aim in the appended claims is to cover all such changes and modifications as fall within the true spirit and scope of the invention.

The invention claimed is:

1. A compound of formula (1) 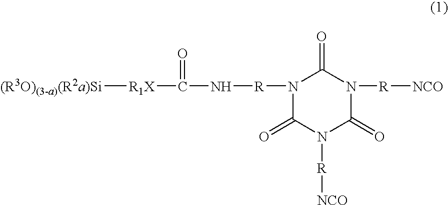
or of formula (2) 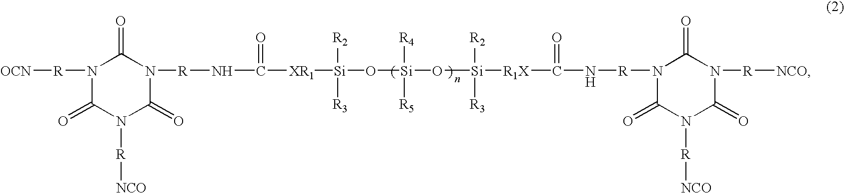
wherein
R represents tolyl, ethylphenyl, diphenylmethyl, 1,5-naphthyl, hexamethylene, isophorone, 2,2,6-trimethylcyclohexyl, or 4,4-dicyclohexylmethyl;
R₁ represents saturated or unsaturated and linear or branched C₁₋₈ alkyl, cycloalkyl, aryl, or a homologue of aromatic hydrocarbon;
R² and R³ at each occurrence separately represent C₁₋₆ alkyl, aryl, trialkylsilyl, or methoxyalkoxyl;
a is an integer from 0 to 3;
R₁, R₂, R₃, R₄, and R₅ at each occurrence separately represent saturated or unsaturated and linear or branched C₁₋₁₂ alkyl, cycloalkyl, alkoxyl, or aryl;
X represents —NH—, —NHCH₂CH₂NH—, —NHCH₂CH₂NHCH₂CH₂NH—, —N—, —NHCONH—, 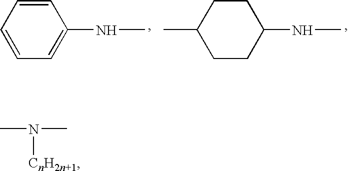
—S—, or —O—; and
n is an integer which is ≧0.

2. A method of preparing the compound of claim 1, comprising steps of
a) dissolving an isocyanate trimer into an inert solvent;
b) adding dropwise to a mixture of silane or functional polysiloxane and a catalyst;
c) stirring the resultant solution at room temperature and in a dry surrounding; and
d) removing said inert solvent under reduced pressure distillation.

3. The method of claim 2, wherein said isocyanate trimer is represented by the following formula 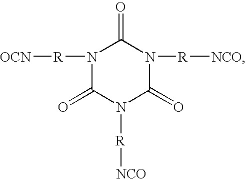
wherein R represents tolyl, ethylphenyl, diphenylmethyl, 1,5-naphthyl, hexamethylene, isophorone, 2,2,6-trimethylcyclohexyl, or 4,4-dicyclohexylmethyl.

4. The method of claim 3, wherein said isocyanate is toluene diisocyanate, ethylbenzene diisocyanate, methylene diphenyl diisocyanate, 1,5-naphthalene diisocyanate, hexamethylene diisocyanate, isophorone diisocyanate, 1,4-diisocyanate-2,2,6-trimethyl cyclohexane, or 4,4-bis(isocyanatecyclohexyl)methane.

5. The method of claim 2, where said silane or functional polysiloxane is represented by formula of
(R³O)₍₃₋ₐ₎(R²a)Si—R₁XH
or 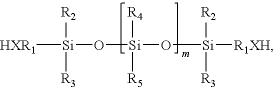
wherein
R² and R³ at each occurrence separately represent C₁₋₆ alkyl, aryl, trialkylsilyl, or methoxylalkoxyl;
a is an integer from 0 to 3;
R₁, R₂, R₃, R₄, and R₅ at each occurrence separately represent saturated or unsaturated and linear or branched C₁₋₁₂ alkyl, aryl, cycloalkyl, alkoxyl, or cycloalkoxyl;
X represents —NH—, —NHCH₂CH₂NH—, —NHCH₂CH₂NHCH₂CH₂NH—, N—, —NHCONH—, 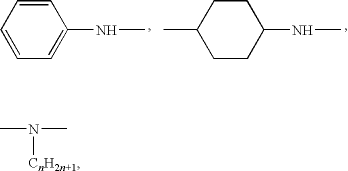
wherein n≧0, —S—, or —O—; and
m is an integer from 0 to 30.

6. The method of claim 3, where said silane or functional polysiloxane is represented by the following formula
(R³O)₍₃₋ₐ₎(R²a)Si—R₁XH
or 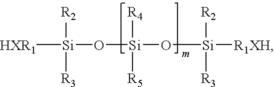
wherein
R² and R³ at each occurrence separately represent C₁₋₆ alkyl, aryl, trialkylsilyl, or methoxylalkoxyl;
a is an integer from 0 to 3;
R₁, R₂R₃, R₄, and R₅ at each occurrence separately represent saturated or unsaturated and linear or branched C₁₋₁₂ alkyl, aryl, cycloalkyl, alkoxyl, or cycloalkoxyl;
X represents —NH—, —NHCH₂CH₂NH—, —NHCH₂CH₂NHCH₂CH₂NH—,
N—, —NHCONH—, 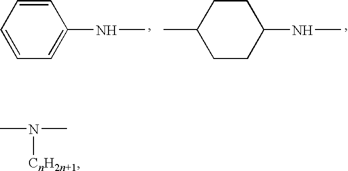
wherein n≧0, —S—, or —O—; and
m is an integer from 0 to 30.

7. The method of claim 2, wherein said catalyst is an organic tin compound.

8. The method of claim 7, wherein said organic tin compound is selected form dibutyltin dilaurate, dibutyltin maleate, dibutyltin diacetate, dibutyltin dilaurylmercaptan, or dimethyltin dichloride.

9. The method of claim 7, wherein said organic tin compound is used in an amount of between 0.01 and 0.5 weight % with respect to the total amount of said isocyanate trimer and said silicon compound.

10. The method of claim 2, wherein said inert organic solvent which does not react with the reactants is hydrocarbon, chlorinated hydrocarbon, ester, or ether.

11. The method of claim 10, wherein said hydrocarbon solvent is petroleum ether, linear or branched hydrocarbon with low boiling point, benzene, toluene, or xylene.

12. The method of claim 10, wherein said chlorinated hydrocarbon is chloroform, chlorobenzene, dichloromethane, or dichloroethane.

13. The method of claim 10, wherein said ester is ethyl acetate.

14. The method of claim 10, wherein said ether is diethyl ether or tetrahydrofuran.

15. The method of claim 2, wherein said isocyanate trimer is used in a molar ratio of 1:1 with respect to active hydrogen of silane or polysiloxane.
